(19) United States
(12) Patent Application Publication
(10) Pub. No.: US 2025/0271089 A1
(43) Pub. Date: Aug. 28, 2025

(54) JOINT

(71) Applicant: HONDA MOTOR CO., LTD., Tokyo (JP)

(72) Inventors: Daichi MATSUYAMA, Tokyo (JP); Hideo KIMURA, Tokyo (JP)

(21) Appl. No.: 19/056,763

(22) Filed: Feb. 19, 2025

(30) Foreign Application Priority Data
Feb. 23, 2024 (CN) 202420337374.1

(51) Int. Cl. F16L 43/00; B60K 11/02; F16L 55/07

(52) U.S. Cl. CPC F16L 43/00; B60K 11/02; F16L 55/07

(57) ABSTRACT

Provided is a joint that connects a cooling medium discharge port through which a cooling medium is discharged from a radiator and a tube which allows the cooling medium to flow toward a downstream side, and that has a gas-liquid separation function. A joint is applicable to a radiator that exchanges heat between a cooling medium and outside air, is capable of allowing the cooling medium discharged from a cooling medium discharge port of the radiator to flow toward a downstream side and performing gas-liquid separation of the cooling medium, and includes: a first connection port connectable to the cooling medium discharge port; a second connection port connectable to a tube that allows the cooling medium to flow toward the downstream side; and an air discharge port through which air separated from the cooling medium is discharged. A center of the second connection port is located below a center of the first connection port. The joint further includes a first tubular portion having the first connection port; a second tubular portion having the second connection port; and a coupling portion coupling the first tubular portion to the second tubular portion such that an axis of the first connection port and an axis of the second connection port form an angle of one degree or greater with each other. The air discharge port is provided in an upper portion of the coupling portion.

This application is based on and claims the benefit of priority from Chinese Patent Application No. CN202420337374.1, filed on 23 Feb. 2024, the content of which is incorporated herein by reference.

### BACKGROUND OF THE INVENTION

### Field of the Invention

The present invention relates to a joint, and more particularly, to a joint that connects a discharge port through which a cooling medium is discharged from a radiator to a tube allowing the cooling medium to flow toward a downstream side.

### Related Art

In recent years, research and development for contributing to energy efficiency has been carried out in order to ensure many people have access to affordable, reliable, sustainable, and advanced energy. There is a radiator that cools a cooling medium by exchanging heat between the cooling medium and outside air. When air is mixed into the cooling medium, there may be a possibility that an air lock is generated and a desired discharge pressure cannot be obtained, whereby the cooling efficiency may decrease. In order to address this problem, it is conceivable to impart a gas-liquid separating function to a joint that connects a cooling medium discharge port provided to a radiator to a tube allowing the cooling medium to flow toward a downstream side.

PCT International Publication No. WO 2023/161849 discloses an L-shaped joint that can be installed between various liquid flow paths. This joint includes an inlet-side tubular portion and an outlet-side tubular portion that form an angle of 90 degrees, and is configured such that a flow path having a circular cross section changes in direction by 90 degrees inside the joint.
Patent Document 1: PCT International Publication No. WO 2023/161849

### SUMMARY OF THE INVENTION

However, since the joint disclosed in PCT International Publication No. WO 2023/161849 is configured such that the axis of the inlet-side flow path and the axis of the outlet-side flow path intersect with each other at 90 degrees, there is a problem in that an inner wall portion with which the cooling medium collides when flowing is small, and it is difficult to impart to the joint a gas-liquid separation function of discharging air separated from the cooling medium to the outside.

In order to solve the above problem, the present application has an object to impart a gas-liquid separation function to a joint that connects a cooling medium discharge port of a radiator to a tube for allowing the cooling medium to flow toward a downstream side. The present invention contributes to energy efficiency by extension.

To achieve the above object, the present invention has a first feature in which a joint is applicable to a radiator that exchanges heat between a cooling medium and outside air, is capable of allowing the cooling medium discharged from a cooling medium discharge port of the radiator to flow toward a downstream side and performing gas-liquid separation of the cooling medium, and includes: a first connection port connectable to the cooling medium discharge port; a second connection port connectable to a tube that allows the cooling medium to flow toward the downstream side; and an air discharge port through which air separated from the cooling medium is discharged, and a center of the second connection port is located below a center of the first connection port.

The present invention has a second feature in which the joint further includes: a first tubular portion having the first connection port; a second tubular portion having the second connection port; and a coupling portion coupling the first tubular portion to the second tubular portion such that an axis of the first connection port and an axis of the second connection port form an angle of one degree or greater with each other, and the air discharge port is provided in an upper portion of the coupling portion.

The present invention has a third feature in which an inner diameter of the first connection port is larger than an inner diameter of the second connection port.

The present invention has a fourth feature in which a lower end of the first connection port and a lower end of the second connection port are located at the same height.

The present invention further has a fifth feature in which a vehicle includes a joint applicable to a radiator that exchanges heat between a cooling medium and outside air, capable of allowing the cooling medium discharged from a cooling medium discharge port of the radiator to flow toward a downstream side and performing gas-liquid separation of the cooling medium, and including: a first connection port connected to the cooling medium discharge port; and a second connection port connected to a tube that allows the cooling medium to flow toward the downstream side, and a center of the second connection port is located below a center of the first connection port.

By virtue of the first feature, in which a joint is applicable to a radiator that exchanges heat between a cooling medium and outside air, is capable of allowing the cooling medium discharged from a cooling medium discharge port of the radiator to flow toward a downstream side and performing gas-liquid separation of the cooling medium, and includes a first connection port connectable to the cooling medium discharge port, a second connection port connectable to a tube that allows the cooling medium to flow toward the downstream side, and an air discharge port through which air separated from the cooling medium is discharged, and a center of the second connection port is located below a center of the first connection port, the centers of the two connection ports are vertically offset from each other, and consequently, an inner wall portion with which the cooling medium collides when flowing is formed. The collision of the cooling medium with the inner wall portion promotes separation of air, thereby making it possible to perform the gas-liquid separation with efficiency. As a result, an air lock and a decrease in discharge pressure can be prevented, and the cooling efficiency of the radiator is maintained high.

By virtue of the second feature, in which the joint further includes a first tubular portion having the first connection port, a second tubular portion having the second connection port, and a coupling portion coupling the first tubular portion to the second tubular portion such that an axis of the first connection port and an axis of the second connection port form an angle of one degree or greater with each other, and the air discharge port is provided in an upper portion of the coupling portion, the first connection port and the second connection port are connected to each other at a predetermined angle, whereby the cooling medium flowing toward the downstream side is further likely to collide with the inner wall portion of the joint. As a result, the gas separated from the cooling medium is pushed upward by an increased force, and the efficiency of gas-liquid separation can be enhanced.

By virtue of the third feature, in which an inner diameter of the first connection port is larger than an inner diameter of the second connection port, a flow path for the cooling medium is reduced in diameter in the coupling portion, thereby making it possible to further enhance the efficiency of the gas-liquid separation.

By virtue of the fourth feature, in which a lower end of the first connection port and a lower end of the second connection port are located at the same height, it is possible to reduce a pressure loss that is caused by the reduction of the diameter of the flow path for the cooling medium in the coupling portion.

By virtue of the fifth feature, in which a vehicle includes a joint applicable to a radiator that exchanges heat between a cooling medium and outside air, capable of allowing the cooling medium discharged from a cooling medium discharge port of the radiator to flow toward a downstream side and performing gas-liquid separation of the cooling medium, and including a first connection port connected to the cooling medium discharge port and a second connection port connected to a tube that allows the cooling medium to flow toward the downstream side, and a center of the second connection port is located below a center of the first connection port, the centers of the two connection ports are vertically offset from each other, and consequently, an inner wall portion with which the cooling medium collides when flowing is formed. The collision of the cooling medium with the inner wall portion makes it possible to perform the gas-liquid separation with efficiency. As a result, the cooling efficiency of the radiator included in the vehicle can be enhanced.

### BRIEF DESCRIPTION OF THE DRAWINGS

FIG. 1 is a perspective view of a power unit chamber of a vehicle according to an embodiment of the present invention;

FIG. 2 is a perspective view illustrating a state in which a joint according to an embodiment is attached to a radiator;

FIG. 3 is a perspective view of the joint;

FIG. 4 is a cross-sectional view of the joint;

FIG. 5 is a cross-sectional view illustrating a state in which the joint is attached to the radiator; and

FIG. 6 is a perspective view of the join and illustrates a shape of a flow path.

### DETAILED DESCRIPTION OF THE INVENTION

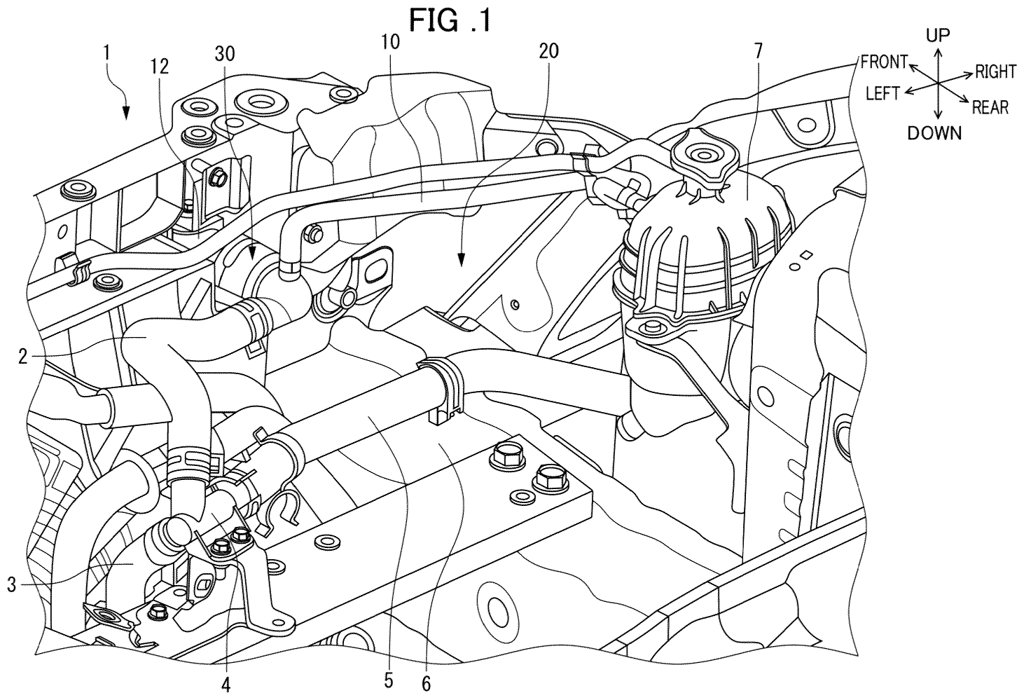

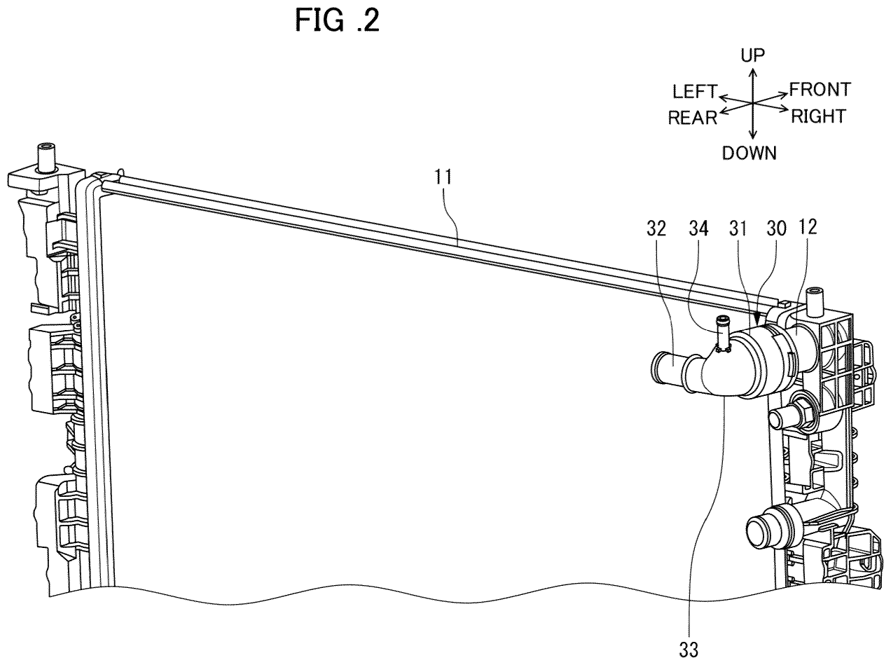

Preferred embodiments of the present invention will be described below in detail with reference to the drawings. FIG. 1 is a perspective view of a power unit chamber 20 of a vehicle 1 according to an embodiment of the present invention. FIG. 2 is a perspective view illustrating a state in which a joint 30 according to the present embodiment is attached to a radiator 11. The radiator 11 cools a cooling medium by exchanging heat between the cooling medium and outside air, and is installed in the power unit chamber 20 of the vehicle 1 that is a four-wheeled automobile having a vehicle cabin. In the power unit chamber 20, the radiator 11 is disposed at a position closer to the front in order to actively have airflow impinged thereon during traveling. The radiator 11 is supported on a vehicle body frame 6 that constitutes the power unit chamber 20. A catch mechanism that holds a hood (not shown) in a closed state is attached to the vehicle body frame 6.

The joint 30 is connected to a cooling medium discharge port 12 that stands rearward on an upper right part of the radiator 11. The joint 30 connects the cooling medium discharge port 12 of the radiator 11 to a hose 2 for allowing the cooling medium to flow toward a downstream side, and has a gas-liquid separation function of separating air from the cooling medium. A second hose 10 through which a cooling medium containing a large amount of air separated from the cooling medium is sent to a reservoir tank 7 is connected to an upper portion of the joint 30. The hose as a tube can be made of one or more of various materials such as rubber, metal, etc.

The joint 30 includes a first tubular portion 31 connected to the cooling medium discharge port 12, a second tubular portion 32 connected to the hose 2, and a coupling portion 33 that couples the first tubular portion 31 to the second tubular portion 32. A cylindrical degassing nipple 34 to which the second hose 10 is connected is provided in an upper portion of the coupling portion 33. The first tubular portion 31 is provided with a quick lock mechanism that is locked upon engagement of a lock pin 37 when the first tubular portion 31 pressed into the cooling medium discharge port 12 to a predetermined position.

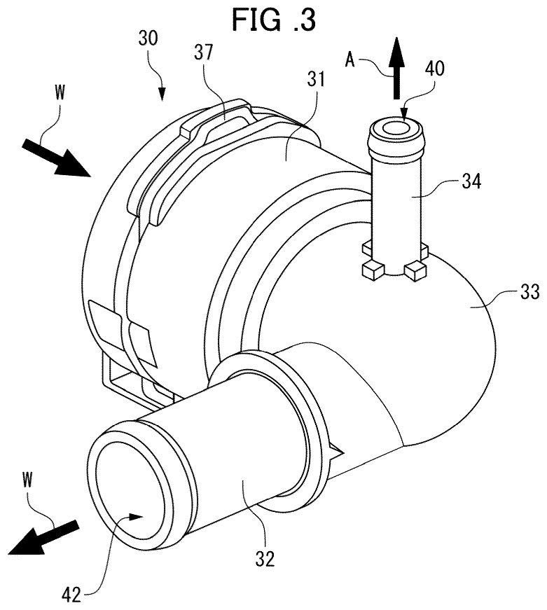

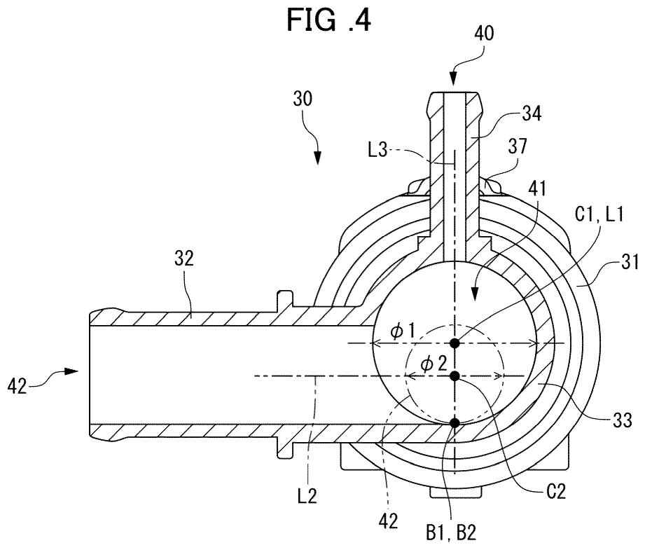

FIG. 3 is a perspective view of the joint 30. FIG. 4 is a cross-sectional view of the joint 30. The same reference numerals as those described above denote the same or equivalent portions. FIG. 4 illustrates a cross section along a plane passing through the axis L2 of a second connection port 42 provided to the second tubular portion 32 and the axis L3 of an air discharge port 40 provided to the degassing nipple 34. The joint 30 is a one-piece component made of a hard synthetic resin or the like, and includes the first tubular portion 31 having a first connection port 41, the second tubular portion 32 having the second connection port 42, and the coupling portion 33 that couples the first tubular portion 31 to the second tubular portion 32. The cooling medium W is introduced from the first connection port 41, changes in its flowing direction by 90 degrees in the coupling portion 33, and then, is discharged through the second connection port 42. Air A separated from the cooling medium is discharged upward through the air discharge port 40 formed in the degassing nipple 34 that extends upward from the coupling portion 33. In the present embodiment, the axis L1 of the first connection port 41 and the axis L2 of the second connection port 42 are configured to form an angle of 90 degrees.

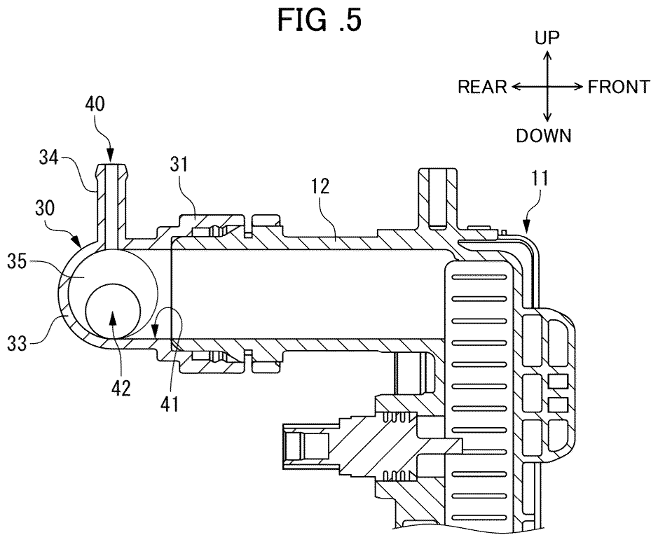

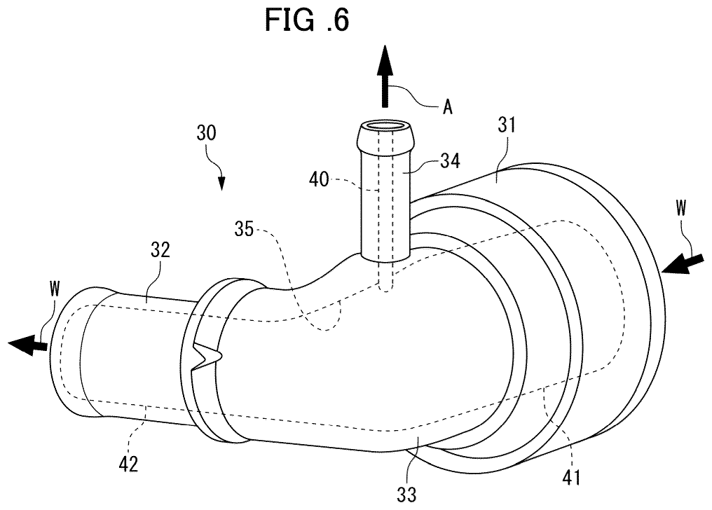

The joint 30 according to the present embodiment has a feature in which the center C2 of the second connection port 42 is located below the center C1 of the first connection port 41. Thus, since the centers of the two connection ports are vertically offset from each other, an inner wall portion 35 (see FIGS. 5 and 6) with which the cooling medium W collides when flowing is formed, and the collision of the cooling medium W with the inner wall portion 35 promotes separation of air A, thereby making it possible to perform the gas-liquid separation with efficiency. As a result, an air lock and a decrease in discharge pressure can be prevented, and the cooling efficiency of the radiator 11 is maintained high.

Another feature is that the joint 30 includes the coupling portion 33 that couples the first tubular portion 31 to the second tubular portion 32 such that the axis L1 of the first connection port 41 and the axis L2 of the second tubular portion 32 form an angle of one degree or greater with each other, and the air discharge port 40 is provided in an upper portion of the coupling portion 33. Thus, the first connection port 41 and the second connection port 42 are connected to each other at a predetermined angle, whereby the cooling medium flowing toward the downstream side is further likely to collide with the inner wall portion 35 of the joint. As a result, the gas A separated from the cooling medium is pushed upward by an increased force, and the efficiency of gas-liquid separation can be enhanced. The angle formed by the axis L1 of the first connection port 41 and the axis L2 of the second connection port 42 has 90 degrees in the present embodiment as a non-limiting example, and can be set between 90 degrees and 135 degrees.

In the present embodiment, the inner diameter φ1 of the first connection port 41 is larger than the inner diameter φ2 of the second connection port 42, so that the flow path for the cooling medium is reduced in diameter in the coupling portion 33, thereby making it possible to further enhance the efficiency of the gas-liquid separation.

Furthermore, in the present embodiment, the lower end B1 of the first connection port 41 and the lower end B2 of the second connection port 42 are located at the same height, thereby making it possible to reduce a pressure loss that is caused by the reduction of the diameter of the flow path for the cooling medium in the coupling portion 33.

FIG. 5 is a cross-sectional view illustrating a state in which the joint 30 is attached to the radiator 11. FIG. 6 is a perspective view of the joint 30 and illustrates the shape of the flow path R. The same reference numerals as those described above denote the same or equivalent portions. FIG. 5 illustrates a cross section along a vertical plane passing through the axis L1 of the first connection port 41. The air discharge port 40 is provided at a position where the axis L1 of the first connection port 41 intersects with the axis L2 of the second connection port 42 in a plan view of the radiator 11.

In the present embodiment, the inner diameter φ1 of the first connection port 41 is larger than the inner diameter φ2 of the second connection port 42, and the lower end B1 of the first connection port 41 and the lower end B2 of the second connection port 42 are located at the same height. Due to this configuration, the cooling medium W introduced from the first connection port 41 is guided downward while colliding with the inner wall portion 35 in the coupling portion 33, and passes through the flow path R that decreases in diameter while smoothly curving by 90 degrees, and then, is discharged through the second connection port 42. As a result, the gas-liquid separation can be efficiently performed while the pressure loss is reduced, and the cooling efficiency of the radiator 11 can be maintained high.

The form and configuration of the vehicle, the shape and structure of the radiator, the shape and structure of the joint, the material of the joint and those of the hoses, the inner diameter dimension of the first connection port and that of the second connection port, the shape and structure of the first tubular portion and those of the second tubular portion, the arrangement of the air discharge port, the angle formed by the axis of the first connection port and the axis of the second connection port, and the like are not limited to those described in the above embodiment, and various modifications can be made. The joint according to the present invention is not limited to application in a flow path for a cooling medium used in a radiator and the like, and can be installed in various liquid flow paths.

### EXPLANATION OF REFERENCE NUMERALS

1: Vehicle
2: Hose (tube)
11: Radiator
12: Cooling medium discharge port
30: Joint
31: First tubular portion
32: Second tubular portion
33: Coupling portion
40: Air discharge port
41: First connection port
42: Second connection port
L1: Axis of first connection port
L2: Axis of second connection port
B1: Lower end of first connection port
B2: Lower end of second connection port
C1: Center of first connection port
C2: Center of second connection port
φ1: Inner diameter of first connection port
φ2: Inner diameter of second connection port
W: Cooling medium
A: Air

What is claimed is:

1. A joint applicable to a radiator that exchanges heat between a cooling medium and outside air, the joint being capable of allowing the cooling medium discharged from a cooling medium discharge port of the radiator to flow toward a downstream side and performing gas-liquid separation of the cooling medium, and comprising:
a first connection port connectable to the cooling medium discharge port;
a second connection port connectable to a tube that allows the cooling medium to flow toward the downstream side; and
an air discharge port through which air separated from the cooling medium is discharged, wherein
a center of the second connection port is located below a center of the first connection port.

2. The joint according to claim 1, further comprising:
a first tubular portion having the first connection port;
a second tubular portion having the second connection port; and
a coupling portion coupling the first tubular portion to the second tubular portion such that an axis of the first connection port and an axis of the second connection port form an angle of one degree or greater with each other, wherein
the air discharge port is provided in an upper portion of the coupling portion.

3. The joint according to claim 2, wherein
an inner diameter of the first connection port is larger than an inner diameter of the second connection port.

4. The joint according to claim 3, wherein
a lower end of the first connection port and a lower end of the second connection port are located at a same height.

5. A vehicle comprising a joint applicable to a radiator that exchanges heat between a cooling medium and outside air, the joint being capable of allowing the cooling medium discharged from a cooling medium discharge port of the radiator to flow toward a downstream side and performing gas-liquid separation of the cooling medium,
the joint comprising:
a first connection port connected to the cooling medium discharge port; and
a second connection port connected to a tube that allows the cooling medium to flow toward the downstream side, wherein
a center of the second connection port is located below a center of the first connection port.
